(19) United States
(12) Patent Application Publication
(10) Pub. No.: US 2022/0351269 A1
(43) Pub. Date: Nov. 3, 2022

(54) MOMENTUM BLENDED RECOMMENDATION ENGINE

(71) Applicant: Kyndryl, Inc., New York, NY (US)

(72) Inventors: Prathima Maskeri, Chantilly, VA (US); Jyoti Jitesh Chawla, Morrisville, NC (US); Stefan A. G. Van Der Stockt, Austin, TX (US)

(21) Appl. No.: 17/245,323

(22) Filed: Apr. 30, 2021

(51) Int. Cl. G06Q 30/06; G06Q 30/02; G06F 16/9535; G06F 40/20; G06K 9/62

(52) U.S. Cl. CPC G06Q 30/0631; G06Q 30/0204; G06F 16/9535; G06F 40/20; G06K 9/6257

(57) ABSTRACT

A method, computer system, and a computer program product for personalized recommendations is provided. The present invention may include determining a momentum score for each item of a training data set. The present invention may include querying a recommendation engine for an initial list of items. The present invention may include generating a blended score for each item of the initial list of items, wherein the blended score is determined based on the momentum score and the confidence score for each item of the initial list of items. The present invention may include presenting a personalized list of recommendations to the user based on the blended score for each item of the initial list of items.

### BACKGROUND

The present invention relates generally to the field of computing, and more particularly to recommendation engines.

A recommendation engine may be used in one or more areas, such as, but not limited to, playlist recommendations for music, product recommendations for online stores, content recommenders for social media platforms, accommodation recommendations for travel, amongst others. Recommendation engines may make use of either or both collaborative filtering and content-based filtering, as well as other knowledge-based systems based on user engagement with a platform. Collaborative filtering approaches may build a model from a user's past behavior as well as similar decisions made by other users, which may be used to recommend other items the user may have interest in. Content-based filtering may utilize a series of discrete pre-tagged characteristics of an item in order to recommend additional items with similar properties.

A recommendation engine may combine one or more approaches into a hybrid system.

### SUMMARY

Embodiments of the present invention disclose a method, computer system, and a computer program product for personalized recommendations. The present invention may include determining a momentum score for each item of a training data set. The present invention may include querying a recommendation engine for an initial list of items. The present invention may include generating a blended score for each item of the initial list of items, wherein the blended score is determined based on the momentum score and the confidence score for each item of the initial list of items. The present invention may include presenting a personalized list of recommendations to the user based on the blended score for each item of the initial list of items.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for personalized recommendations according to at least one embodiment;

FIG. 3 is a block diagram of internal and external components of computers and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for personalized recommendations. As such, the present embodiment has the capacity to improve the technical field of recommendation engines by presenting a personalized list of recommendations to a user based on a blended score for an item, the blended score being determined based on a momentum score and confidence score. More specifically, determining a momentum score for each item of a training data set, querying a recommendation engine for an initial list of items, wherein each item of the initial list of items has a confidence score assigned by the recommendation engine and wherein the initial list of items are determined based on user activity, generating a blended score for each item of the initial list, wherein the blended score is determined based on the momentum score and the confidence score for each item of the initial list of items, and presenting a personalized list of recommendations to the user based on the blended score for each item of the initial list of items.

As described previously, a recommendation engine may be used in one or more areas, such as, but not limited to, playlist recommendations for music, product recommendations for online stores, content recommenders for social media platforms, accommodation recommendations for travel, amongst others. Recommendation engines may make use of either or both collaborative filtering and content-based filtering, as well as other knowledge-based systems. Collaborative filtering approaches may build a model from a user's past behavior as well as similar decisions made by other users, which may be used to recommend other items the user may have interest in. Content-based filtering may utilize a series of discrete pre-tagged characteristics of an item in order to recommend additional items with similar properties.

A recommendation engine may combine one or more approaches into a hybrid system.

Therefore, it may be advantageous to, among other things, determine a momentum score for each item, query a recommendation engine for an initial list of items, generate a blended score for each item of the initial list, and present a personalized list of recommendations to the user based on the blended score for each item.

According to at least one embodiment, the present invention may improve items presented to a user by utilizing a momentum score to re-rank an initial list of items generated by a recommendation engine.

According to at least one embodiment, the present invention may improve items recommended to a user by utilizing a policy dimension. The policy dimension may allow a user to effortlessly comply with one or more rules, such as, but not limited to, company policies, regulations, laws, amongst others. A user may also manually input causes and/or beliefs held by the user which the recommendation program will weight in real time based on data pulled from external sources.

According to at least one embodiment, the present invention may improve the understanding of user preferences by monitoring engagement of the user with an item of a personalized list. The recommendation program may update the data set and update the momentum score for each item of the data set based on user feedback.

According to at least one embodiment, the present invention may improve items recommended to a user by recommending items based on a blended score. The blended score may consider both a confidence score generated by a recommendation engine and the momentum score generated by a momentum engine. The recommendation engine may determine the blended score utilizing one or more methods, such as, but not limited to, confidence boosting and/or uncorrelated filtering.

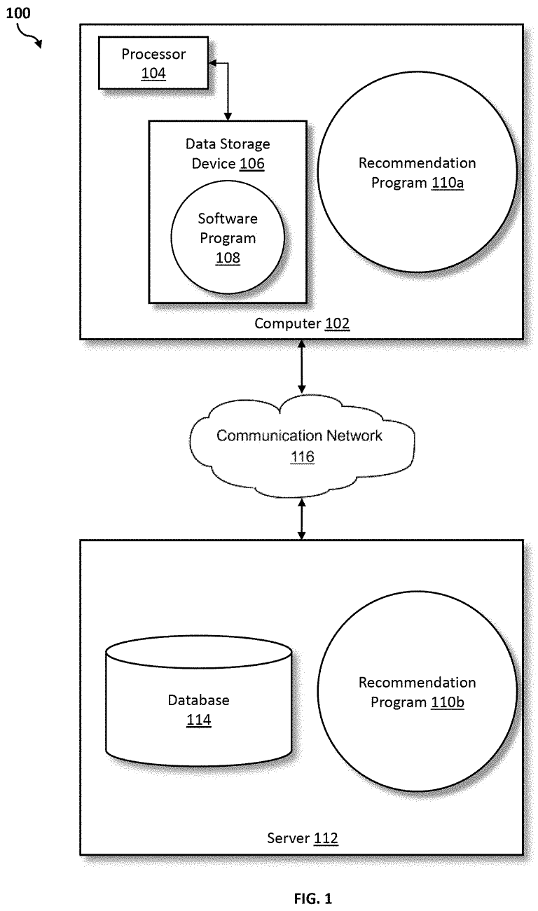

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a recommendation program 110a. The networked computer environment 100 may also include a server 112 that is enabled to run a recommendation program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

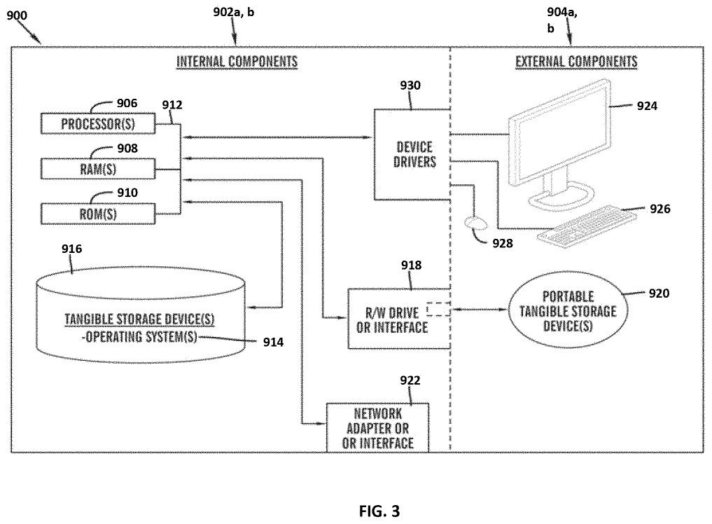

The client computer 102 may communicate with the server computer 112 via the communications network 116. The communications network 116 may include connections, such as wire, wireless communication links, or fiber optic cables. As will be discussed with reference to FIG. 3, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the recommendation program 110a, 110b may interact with a database 114 that may be embedded in various storage devices, such as, but not limited to a computer/mobile device 102, a networked server 112, or a cloud storage service.

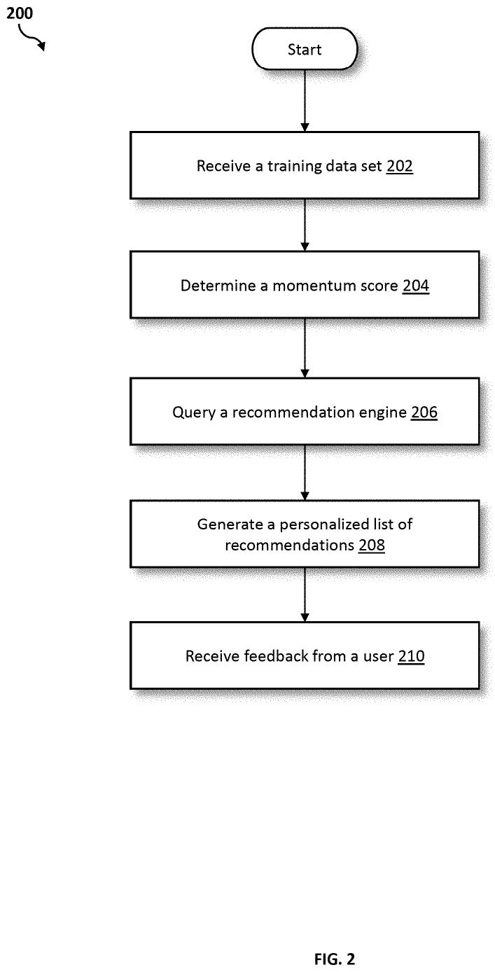

According to the present embodiment, a user using a client computer 102 or a server computer 112 may use the recommendation program 110a, 110b (respectively) to present a personalized list of recommendations to a user. In various embodiments of the invention, recommendation program 110, may execute locally on client computer 102 as a plug-in to an internet browser, as a dedicated software application. In alternative embodiments, the recommendation program 110 may execute on server computer 112. The personalized recommendation method is explained in more detail below with respect to FIG. 2.

Referring now to FIG. 2, an operational flowchart illustrating the exemplary personalized recommendation process 200 used by the recommendation program 110a and 110b (hereinafter recommendation program 110) according to at least one embodiment is depicted.

At 202, the recommendation program 110 receives a training data set. The training data set may be data utilized in training a recommendation engine. A recommendation engine may be a trained model utilized in providing recommendations to users. The recommendation program 110 may reformat the training data set by user and item. The user may be a participant of a platform utilizing the recommendation engine where an item may be a product or service available to the user.

A recommendation engine may utilize collaborative filtering (e.g., user-user collaborative filtering), content-based filtering (e.g., item-item collaborative filtering), or a hybrid of the two. A recommendation engine utilizing collaborative filtering may provide recommendations to the user based on other users. A recommendation engine utilizing content-based filtering may provide a recommendation for another item based on the item in which the user is currently engaging. Users may receive recommendations based on other users with similar search histories and/or similar browsing behaviors.

The recommendation engine may assign confidence scores for items based on determined similar users or similar items engaged in by the user. The recommendation engine may assign a confidence score to each item for a user, the confidence score may be a numerical value between 0 and 1. For example, two different users with the same purchase history may have the same confidence scores with respect to the same items.

For example, a recommendation engine used in booking travel accommodations may recommend accommodations to a user based on one or more determined similar users or items associated with the user's selected destination. The training data set for the recommendation engine may include, but is not limited to including data such as, previous bookings, destinations, flights, hotels, ground transportation, restaurants, entertainment, ratings, amongst others, for all users of a platform. The recommendation engine may be trained using one or more algorithms, such as, but not limited to, item-item collaborative filtering, user-user collaborative filtering, matrix factorization, k-nearest neighbor, amongst others.

At 204, the recommendation program 110 determines a momentum score. The recommendation program 110 may determine the momentum score for each item of the training data set. The recommendation program 110 may utilize a reformatted data set in determining the momentum score for each item, wherein the reformatted data set may be organized by user and item. The recommendation program 110 may utilize a momentum engine in determining the momentum score for each item of the training data set. The momentum engine may be algorithm based model. The recommendation program 110 may update the momentum score for each item in real time based on the real-time data.

The recommendation program 110 may determine the momentum score by normalizing a momentum score for each of the one or more dimensions of an item. The one or more dimensions may include, but are not limited to including, a behavioral dimension, a declarative dimension, and a policy dimension. The one or more dimensions of the item may be utilized as input for the momentum engine.

The recommendation program 110 may determine the momentum score for each behavioral dimension by extracting behavioral data from the training data set for each user. The recommendation program 110 may extract the behavioral data from the training data set for each user utilizing techniques such as, but not limited to, optical character recognition (“OCR”) and/or natural language processing (NLP). In an embodiment of the invention, an Artificial Intelligence (AI) tool is trained based upon the extracted behavioral data. Behavioral data may include, but is not limited to including, recency, frequency, and monetary, for each item of the training data set for each user. The behavioral data extracted from the training data set may include, but is not limited to including, purchasing dates, purchasing prices, characteristics of purchases, amongst other data. The trained AI tool may be utilized to find patterns or make predictions based on the behavioral data.

In determining the momentum score for recency, frequency, and monetary the recommendation program 110 may utilize each of the following equations:

$$R ( t ) {I}_{i} = \{ \begin{matrix}1 & if item {I}_{i} is more recent than other items {I}_{j} , ∀ j \\ 0 & Otherwise\end{matrix}$$

$$F ( t ) {I}_{i} = \frac{{n}_{i}}{{n}_{k}}$$

$$M ( t ) {I}_{i} = \frac{{p}_{i}}{{n}_{k}}$$

R(t)Iᵢ may be the recency momentum score for item Iᵢ as compared to other items, Iⱼ. Time may be represented by t, wherein time t may be set as a user configurable option. The user configurable option may allow time to be set in intervals such as, but not limited to, months, days, weeks, days, hours, minutes, seconds. Time t may also be set by the recommendation program 110 based on the engagement of the user with the platform. ∀j may represent for all other items Iⱼ. F(t)Iᵢ may be the frequency momentum score for item Iᵢ, where nᵢ may represent the total number of items in which the user has previously purchased or utilized, and nₖ may represent the total number of comparable items (e.g., products, services). M(t)Iᵢ may be the monetary momentum score for item Iᵢ, where pᵢ may represent the amount of times in which the user has purchased or utilized item Iᵢ, and nₖ may represent the total number of comparable items (e.g., products, services). For each behavioral dimension (e.g., recency, frequency, monetary) the recommendation program 110 may determine a momentum score. The momentum score may be a value between 0 and 1.

In determining the momentum score for the behavioral dimension of an item, the recommendation program 110 may utilize variables R(t)Iᵢ, F(t)Iᵢ, and M(t)Iᵢ, as provided in the following equation:

$$Δ m ( t ) {I}_{i} = \frac{R ( t ) {I}_{i} + F ( t ) {I}_{i} + M ( t ) {I}_{i} …}{D}$$

$$where$$

$$m ( t ) {I}_{i} = λ m ( t - 1 ) {I}_{i} + ( 1 - λ ) Δ m ( t ) {I}_{i}$$

Δm(t)Iᵢ may represent the change in the momentum score over time t which may be determined for each time interval. D in the above equation may represent the number of dimensions utilized by the recommendation program 110 in determining the momentum score. For example, if the recommendation engine determines each behavioral dimension, recency, frequency, and monetary, the value of D is 3. Δm(t)Iᵢ may be utilized in the m(t)Iᵢ determination to determine how each momentum calculation for each time t may influence a new momentum score. λm(t−1)Iᵢ may be a parameter utilized to determine the influence of a momentum score determined at time t influences the new momentum score. Lambda, λ, may a value between 0 and 1.

The recommendation program 110 may also consider, but is not limited to considering, a declarative dimension and a policy dimension in determining the momentum score for each item. A declarative dimension may be a preference setting specific to a user. The declarative dimension may be manually input by a user. For example, a user may be gluten free. Accordingly, the recommendation program 110 may negatively weight the momentum score for items containing gluten, such that they will not be recommended to the user. The declarative dimension may also be extracted from the training data based on purchase history. For example, if the user has repeatedly booked Hotel A over Hotel B (as indicated from the training data set), the recommendation program 110 may positively weight Hotel A and negatively weight Hotel B, such that even if Hotel A may be appear to be a less desirable option to Hotel B based on the recommendation engine, the user may be recommended Hotel A over Hotel B. The declarative dimension extracted from the training set data may not be weighted as heavily as a manually input declarative dimension.

A policy dimension may be one or more rules with antecedent conditions and consequent actions. The one or more rules may be derived from, but are not limited to being derived from, company policies, regulations, laws, user patterns, user policy, amongst others. For example, a company policy may require parts to be ordered from a particular vendor or not to order parts within a given number of days before month-end. The recommendation program 110 may weight the momentum scores of items such that a user may only be recommended items in accordance with the company policy. The user may also provide manual input for the policy dimension such that the recommendation program 110 may negatively weight items or services determined to be antithetical to causes and/or beliefs of the user.

The recommendation program 110 may utilize the following equation when weighting the declarative dimension and the policy dimension for each item,

$$Δ m ( t ) {I}_{i} = \frac{R ( t ) {I}_{i} + F ( t ) {I}_{i} + M ( t ) {I}_{i} + D ( t ) {I}_{i} + P ( t ) {I}_{i} …}{D}$$

In which D(t)Iᵢ may represent the declarative dimension momentum score for item Iᵢ and P(t)Iᵢ may represent the policy dimension momentum score for item Iᵢ. The declarative dimension momentum score may be a set value for declarative dimensions manually input by a user such that items not aligned with preference settings of the user are not recommended.

The recommendation program 110 may update the momentum score for each item in real-time data. Real-time data may include, but is not limited to including, published service disruptions, news alerts, weather alerts, press releases, public notices, public health data, item reviews, user feedback amongst others. The recommendation program 110 may utilize a web-crawler in extracting real time data. The web-crawler may extract real time data based on at least the browsing activity and/or items of the training data set.

The recommendation program 110 may analyze the real-time data utilizing at least, natural language processing (NLP) techniques, such as those implemented in IBM Watson® (Watson and all Watson-based trademarks are trademarks or registered trademarks of International Business Machines Corporation in the United States, and/or other countries), IBM Watson® Tone Analyzer, and sentiment analysis. The recommendation program 110 may utilize a sentiment (e.g., opinion, feeling, or emotion), including a positive, negative, and/or neutral sentiment, to weight the momentum score of an item, as will be described in more detail below.

The recommendation program 110 may utilize the sentiment determined from real time data in calculating the momentum score for item Iᵢ as outlined above. The sentiment may be utilized as a factor in determining the P(t)Iᵢ and/or utilized as an independent dimension in the momentum score determination.

For example, if the user manually inputs the user does not like products in color X (where X represents a color of the rainbow), the recommendation program 110 may utilize a declarative dimension momentum score of −100 for all items Iᵢ in color X such that color X items may not be recommended to the user. The policy dimension momentum score may be a set value for policy dimensions based on a set of rules. For example, if a company policy limits hotel expenses to $100/night, the recommendation program 110 may utilize a policy dimension momentum score of −100 for all hotels over $100/night, such that the user may only be recommended hotels in accordance with company policy.

At 206, the recommendation program 110 queries the recommendation engine. The recommendation program 110 may query the recommendation engine based on a context vector. The context vector may be based on activity of a user, such as, but not limited to, items a user is viewing, items in a user's cart, items a user has favorited or liked, amongst other user activity. The recommendation program 110 may query the recommendation engine for a list of recommendations based on the context vector. The recommendation engine may generate an initial list of items based on the query of the recommendation program 110, wherein the initial list of items are ordered from highest to lowest confidence score, the confidence score being a numerical value between 0 and 1 determined by the recommendation engine. The initial list of items may include a number of items depending on the query of the recommendation program 110.

The recommendation program 110 may generate a blended score for each item of the initial list. The recommendation program 110 may generate the blended score for each item of the initial list based on the confidence score and the momentum score for each item utilizing one or more methods, including, but not limited to, confidence boosting, uncorrelated filtering, or a combination of confidence boosting and uncorrelated filtering, averaging scores, weighting scores, amongst other methods.

Confidence boosting may add the momentum score to a corresponding confidence score for each item of the initial list. The confidence boosting method may include all items of the initial list. The confidence boosting method may re-order the initial list by elevating items with positive momentum scores, lowering items with negative momentum scores, and leaving items in which a momentum score has not been determined by the recommendation program 110 unchanged.

The uncorrelated filtering method may remove one or more items from the initial list where the momentum score and the confidence score are uncorrelated. The momentum score and the confidence score may be uncorrelated if the difference between the scores is above a threshold level. The threshold level may be a predetermined threshold. The uncorrelated filtering method may remove items from the initial list in which the difference between the scores is above the threshold level and may remove items from the initial list in which a momentum score has not been determined by the recommendation program 110.

The recommendation program 110 may utilize a combination of the confidence boosting method and the uncorrelated filtering method. The combination may reorder the initial list of recommendations using confidence boosting and remove items from the initial list using uncorrelated filtering.

At 208, the recommendation program 110 generates a personalized list of recommendations. The personalized list of recommendations may be an updated initial list based on the blended score for each item. The recommendation program 110 may integrate the personalized list with the platform in which the user is currently active. The recommendation program 110 may present one or more items from the personalized list to the user based on the current activity of the user. The current activity of the user may be determined based on at least items being presented to the user and items the user has engaged recently. The recommendation program 110 may present the personalized list of recommendations to the user by displaying the personalized list of recommendations in at least an internet browser, dedicated software application, amongst others.

For example, the user may select an item to be added to their cart for checkout. The recommendation program 110 may present the user with an item from the personalized list of recommendations to the user as an additional item. In another example, the recommendation program 110 may present the user with an item from the personalized list of recommendations based on the user's history of ordering this item regularly in a consistent time frame.

At 210, the recommendation program 110 receives feedback from the user. The user may provide feedback on the personalized list of recommendations. The user may provide feedback on an item from the personalized list of recommendations based on the engagement of the user with the item. The recommendation program 110 may monitor the engagement of the user with the item by at least, recording the period of time the user evaluated the item, determining whether the user favorited or saved the item, whether the user added the item to a purchase order, or whether the user selected a different item in which to purchase instead of the item from the personalized list of recommendations.

The recommendation program 110 may update the data set based on the feedback and/or actions of the user. The momentum engine may update the momentum score for each item of the data set based on the feedback. The momentum engine may update the momentum score for each item of the data set by adjusting each behavioral dimension. The momentum engine may determine the momentum score for each new item added to the data set.

It may be appreciated that FIG. 2 provides only an illustration of one embodiment and do not imply any limitations with regard to how different embodiments may be implemented. Many modifications to the depicted embodiment(s) may be made based on design and implementation requirements.

FIG. 3 is a block diagram 900 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 3. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the recommendation program 110a in client computer 102, and the recommendation program 110b in network server 112, may be stored on one or more computer-readable tangible storage devices 916 for execution by one or more processors 906 via one or more RAMs 908 (which typically include cache memory). In the embodiment illustrated in FIG. 3, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the recommendation program 110a and 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the recommendation program 110a in client computer 102 and the recommendation program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the recommendation program 110a in client computer 102 and the recommendation program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

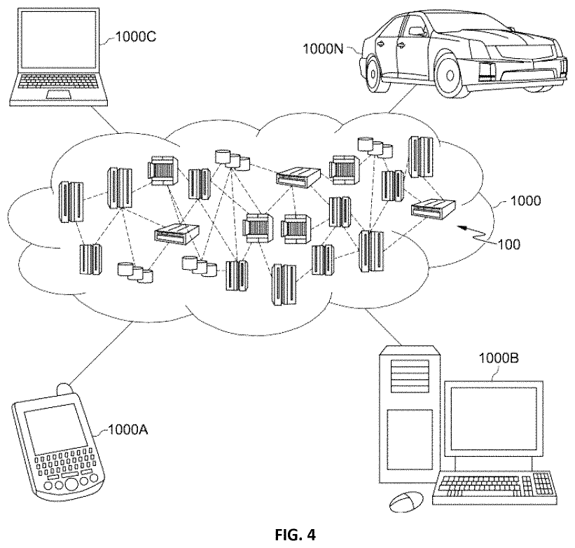

Referring now to FIG. 4, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 4 are intended to be illustrative only and that computing nodes 100 and cloud computing environment 1000 can communicate with any type of computerized device over any type of network and/or network addressable connection (e.g., using a web browser).

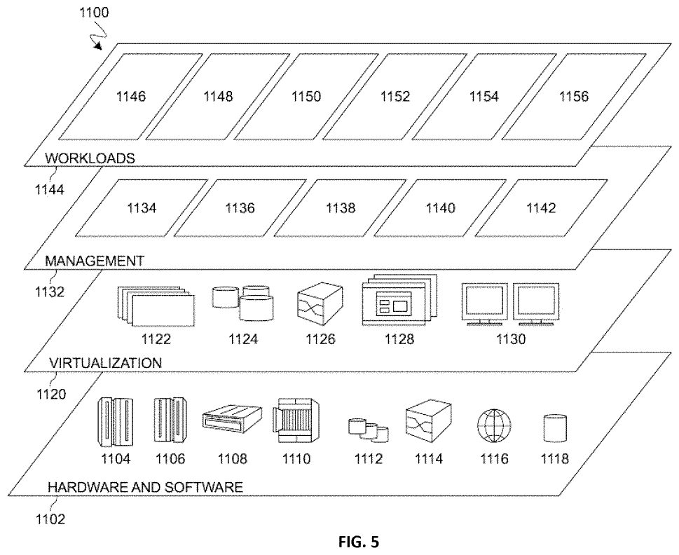

Referring now to FIG. 5, a set of functional abstraction layers 1100 provided by cloud computing environment 1000 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and recommendation program 1156. A recommendation program 110a, 110b provides a way to present a personalized list of recommendations to a user.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

What is claimed is:

1. A method for personalized recommendations, the method comprising:
determining a momentum score for each item of a training data set;
querying a recommendation engine for an initial list of items, wherein each item of the initial list of items has a confidence score assigned by the recommendation engine, and wherein each item of the initial list of items is determined based on user activity;
generating a blended score for each item of the initial list of items, wherein the blended score is determined based on the momentum score and the confidence score for each item of the initial list of items; and
presenting a personalized list of recommendations to the user based on the blended score for each item of the initial list of items.

2. The method of claim 1, wherein the momentum score is based on at least a behavioral dimension, a declarative dimension, and a policy dimension.

3. The method of claim 2, wherein the behavioral dimension is extracted from the training data set using natural language processing.

4. The method of claim 2, wherein the policy dimension is updated in real time based on a sentiment.

5. The method of claim 1, wherein presenting the personalized list of recommendations to the user further comprises:
displaying the personalized list of recommendations to the user in an internet browser, wherein the personalized list of recommendations is updated based on a plurality of user feedback.

6. The method of claim 5, wherein the plurality of user feedback adjusts the behavioral dimension.

7. The method of claim 1, wherein generating the blended score for each item of the initial list further comprises:
reordering the initial list of items using a confidence boosting method; and
removing one or more items from the initial list of items using an uncorrelated filtering method.

8. A computer system for personalized recommendations, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
determining a momentum score for each item of a training data set;
querying a recommendation engine for an initial list of items, wherein each item of the initial list of items has a confidence score assigned by the recommendation engine, and wherein each item of the initial list of items is determined based on user activity;
generating a blended score for each item of the initial list of items, wherein the blended score is determined based on the momentum score and the confidence score for each item of the initial list of items; and
presenting a personalized list of recommendations to the user based on the blended score for each item of the initial list of items.

9. The computer system of claim 8, wherein the momentum score is based on at least a behavioral dimension, a declarative dimension, and a policy dimension.

10. The computer system of claim 9, wherein the behavioral dimension is extracted from the training data set using natural language processing.

11. The computer system of claim 9, wherein the policy dimension is updated in real time based on a sentiment.

12. The computer system of claim 8, wherein the personalized list of recommendations is updated based on a plurality of user feedback.

13. The computer system of claim 12, wherein the user feedback adjusts the behavioral dimension.

14. The computer system of claim 8, wherein generating the blended score for each item of the initial list further comprises:
reordering the initial list of items using a confidence boosting method; and
removing one or more items from the initial list of items using an uncorrelated filtering method.

15. A computer program product for personalized recommendations, comprising:
one or more non-transitory computer-readable storage media and program instructions stored on at least one of the one or more tangible storage media, the program instructions executable by a processor to cause the processor to perform a method comprising:
determining a momentum score for each item of a training data set;
querying a recommendation engine for an initial list of items, wherein each item of the initial list of items has a confidence score assigned by the recommendation engine, and wherein each item of the initial list of items is determined based on user activity;
generating a blended score for each item of the initial list of items, wherein the blended score is determined based on the momentum score and the confidence score for each item of the initial list of items; and
presenting a personalized list of recommendations to the user based on the blended score for each item of the initial list of items.

16. The computer program product of claim 15, wherein the momentum score is based on at least a behavioral dimension, a declarative dimension, and a policy dimension.

17. The computer program product of claim 16, wherein the behavioral dimension is extracted from the training data set using natural language processing.

18. The computer program product of claim 16, wherein the policy dimension is updated in real time based on a sentiment.

19. The computer program product of claim 15, wherein the personalized list of recommendations is updated based on a plurality of user feedback.

20. The computer program product of claim 15, wherein generating the blended score for each item of the initial list further comprises:
reordering the initial list of items using a confidence boosting method; and
removing one or more items from the initial list of items using an uncorrelated filtering method.
